(19) United States
(12) Patent Application Publication
(10) Pub. No.: US 2007/0248054 A1
(43) Pub. Date: Oct. 25, 2007

(54) METHOD FOR RECONFIGURING MOBILITY PLATFORM, AND DEVICE APPLYING THE METHOD

(75) Inventors: Jyh-Cheng Chen, Hsinchu (TW); Jui-Hung Yeh, Hsinchu (TW); Yi-Wen Lan, Hsinchu (TW); Li-Wei Lin, Hsinchu (TW); Fu-Cheng Chen, Hsinchu (TW); Shao-Hsiu Hung, Hsinchu (TW)

Correspondence Address: DARBY & DARBY P.C., P.O. BOX 770, Church Street Station, New York, NY, 10008-0770, US

(73) Assignee: NATIONAL TSING HUA UNIVERSITY, Hsinchu (TW)

(21) Appl. No.: 11/561,929

(22) Filed: Nov. 21, 2006

(30) Foreign Application Priority Data
Apr. 21, 2006 (TW) 095114279

(51) Int. Cl. H04Q 7/00

(52) U.S. Cl. 370/331

(57) ABSTRACT

A method for reconfiguring a mobility platform includes: enabling a mobile node to extract an advertisement signaling packet sent periodically by a network node, wherein the mobile node supports a plurality of client mobility management protocols, and the network node supports a plurality of network mobility management protocols; according to the advertisement signaling packet, enabling the mobile node to display at least one mobility management protocol that is mutually supported by the mobile and network nodes for viewing by a user; enabling the user to select one of the at least one mobility management protocol to serve as a new mobility management protocol to be mutually used by the mobile and network nodes; and enabling the mobile node to send a registration request packet to the network node.

### CROSS-REFERENCE TO RELATED APPLICATION

This application claims priority of Taiwanese Application No. 095114279, filed on Apr. 21, 2006.

### BACKGROUND OF THE INVENTION

1. Field of the Invention

The invention relates to a method and device for configuring a mobility platform, more particularly to a method for reconfiguring a mobility platform and a device applying the method.

2. Description of the Related Art

Nowadays, wireless networks are very popular, and there exist many different wireless network technologies, such as Wireless Local Area Network (WLAN) Second Generation wireless handset communications system, the emerging Third Generation (3G) wireless handset system, etc. These different wireless network systems not only coexist, they also evolve independently and have their own merits and drawbacks. Take the wireless local area network technology as an example, since it provides a faster transmission speed, it is suitable for transmitting multimedia or complicated network data. However, as its signal coverage is limited, it cannot support use by users moving at a high speed. In addition, the handset communications system is the opposite of the wireless local area network. In particular, the bandwidth of the handset communications system is limited, and cannot provide transmission of complicated multimedia data that requires a large bandwidth. However, it has a very large signal coverage, and is able to support transmission by users moving at a high speed.

Although many different wireless network technologies coexist, as a whole, each wireless network technology can be simply divided into two parts: one is the Radio Access Network (RAN), and the other is the Core Network. A radio access network primarily provides hardware resources for users to use and manage. The hardware resources are, e.g., radio channels, etc. A core network primarily interconnects different radio access networks in a wired manner, or connects the thus interconnected radio access networks to other different networks. These different networks maybe the Internet or the Public Switched Telephone Network (PSTN). These different wireless network technologies have their own advantages and disadvantages, and are not interchangeable. Therefore, these different wireless network technologies will continue to coexist in the future. However, a problem arises: How can a user move from one system to another system? Since the radio access network is closest to the user end, a general consensus is to integrate different radio access networks to enable the user to roam among them. In order to achieve this objective, there must be a universal core network. Whether it is in terms of the current technologies or future developments, core network protocols integrated on the basis of the Internet Protocol (IP) are commonly recognized. That is, a user in possession of a product equipped with an interface card having different wireless interfaces can roam among different radio access networks without restriction.

Wireless networks that may exist in the future include 3G RAN, wireless local area networks, and 2.5G RAN. These three different wireless network technologies have their respective signal coverage ranges, which may or may not overlap. As long as the wireless network card of the user has the functionality of receiving and transmitting signals of the above three (or two) types, the user can freely move in and out of these networks without restraint. Because these three different wireless networks have a common core network—IP, through the common core network, the user can use different wireless networks and can also directly access various services and application programs over the Internet.

To enable the user to use different wireless technologies for transmission under different environments, the concept of reconfigurable radio technology has been available, and is termed Software Defined Radio (SDR). Such technology makes use of the easily changeable characteristic of software to alter the primary parameters of the system so as reorganize the functions and specifications of the entire radio, thereby giving the radio hardware that originally had no flexibility more variability and adaptability. Such specially designed radio hardware can allow the user to utilize software to automatically adjust the wireless technology according to requirements at any time in different coverage ranges of different application points.

However, to achieve universal roaming, there should be a common core network. If it is not possible to deploy a common core network, different core networks should be compatible. Unfortunately, different standards organizations have defined their own core networks. For instance, the 3G Partnership Project (3GPP) has defined an IP-based packet core network, which is evolved from GPRS. On the other hand, 3GPP2 has defined a different packet core network architecture capable of supporting IP services.

Like the question faced by radio systems, will the incompatible core networks coexist in the future? Is it possible to define a common and long-term universal core network? While 3GPP and 3GPP2 are working on the harmonization of different systems, it may not be necessary and/or possible to define a single universal core network. Different core networks and protocols may possibly coexist. They might be optimized to meet the requirements of different environments, applications, and even different countries.

As mentioned earlier, although the core networks of 3GPP and 3GPP2 are based on IP, the architectures are different. Besides, their Internet architectures are also different. In addition to network architectures, many protocols are different as well. For instance, the mobility management in 3GPP packet core network is evolved from GPRS Mobility Management (GMM). Packets are tunneled between Gateway GPRS Support Node (GGSN) and mobile station using the GPRS Tunneling Protocol (GTP). Although the mobility management in 3GPP2 can be based on Mobile IP (MIP), details such as handoff procedures and paging are tailor-made for 3GPP2 architecture. In 3GPP2, packets are tunneled between Packet Data Serving Node (PDSN) and the mobile station using Generic Routing Encapsulation (GRE). Compared with MIP and variants of MIP, 3GPP and 3GPP2 provide more complicated and comprehensive solutions, which include hand off, location update, and paging. With many different mobility management protocols, even though a terminal supports multi-mode radio or reconfigurable radio in lower layers, it is still impossible to roam between different core networks.

Generally, mobility management can be categorized into macro-mobility management and micro-mobility management. Macro-mobility management is mostly based on MIP. Micro-mobility management, however, limits the frequent handoffs into micro-domains. It is intended to localize the location update and location registration to reduce handoff latency and end-to-end latency.

Many micro-mobility management protocols have been proposed. Generally, they can be categorized as tunnel-based and host-specific-routing-based protocols. Examples of the tunnel-based micro-mobility management protocols include Hierarchical MIP (HMIP), Intra-Domain Mobility Management Protocol (IDMP), Multicast-based Mobility, and Dynamic HMIP (DHMIP). The tunnel-based protocols usually employ a hierarchical mobility architecture and require a gateway to tunnel packets to and from mobile stations. The mobility management protocols developed by 3GPP and 3GPP2 can be classified under this category.

On the other hand, the host-specific-routing-based protocols adopt new routing schemes to support mobility within micro-domains. That is, standard IP routing is not used inside micro-domains. Examples of this category include Cellular IP, Handoff-Aware Wireless Access Internet Infrastructure (HAWAII), Fast Link-layer and Intra-domain Handoffs (FLIH), and Mobility-aware Multi-Protocol Label Switching (Mobility-aware MPLS).

However, relevant studies have shown that each mobility management protocol possesses different characteristics and merits. There is not a single universal protocol that can be optimized for all environments. Therefore, there is a need for a solution.

### SUMMARY OF THE INVENTION

Therefore, an object of the present invention is to provide a method for reconfiguring a mobility platform, in which when a mobile node (MN) roams into a new domain, a mobility platform of the mobile node and a network node (NN) in the new domain can be reconfigured.

Accordingly, a method for reconfiguring a mobility platform of the present invention includes the following steps. Initially, the mobile node extracts an advertisement signaling packet sent periodically by the network node, wherein the mobile node supports a plurality of client mobility management protocols, and the network node supports a plurality of network mobility management protocols. Next, according to the advertisement signaling packet, the mobile node displays at least one mobility management protocol that is mutually supported by the mobile node and the network node for viewing by a user. Then, the user selects one of the at least one mobility management protocol to serve as a new mobility management protocol to be mutually used by the mobile node and the network node. Subsequently, the mobile node sends a registration request packet to the network node.

Another object of the present invention is to provide a mobile node for reconfiguring a mobility platform such that when the mobile node roams into a new domain, a mobility platform of the mobile node and a network node in the new domain can be reconfigured.

Accordingly, the mobile node for reconfiguring a mobility platform of the present invention includes a platform controller-client (PC-C), a platform registrar-client (PR-C), a plurality of client mobility management modules (MMM-C), a platform controller notifier-client (PCN-C), and a mobility selector (MS). The platform registrar-client is used to record corresponding templates of a plurality of client mobility management protocols. The client mobility management modules correspond to the client mobility management protocols and the templates, and are used to implement the client mobility management protocols. The platform controller notifier-client is used to monitor an advertisement signaling packet from the network node, and sends the advertisement signaling packet to the platform controller-client, wherein the advertisement signaling packet supports at least one of the client mobility management protocols. With reference to the platform registrar-client and the advertisement signaling packet, the mobility selector displays the client mobility management protocols that are supported by the network node for viewing by a user so as to enable the user to select a new mobility management protocol, and sends the selection result to the platform controller-client so as to notify the corresponding client mobility management module accordingly, thereby generating a registration request packet to be sent to the network node.

Still another object of the present invention is to provide a network node for reconfiguring a mobility platform such that when a mobile node roams into a new domain, a mobility platform of the mobile node and the network node in the new domain can be reconfigured.

Accordingly, the network node for reconfiguring a mobility platform of the present invention includes a platform controller (PC), a platform registrar (PR), a plurality of mobility management modules (MMM), a platform controller notifier (PCN), and a mobile node information database (MID). The platform registrar is used to record corresponding templates of a plurality of network mobility management protocols, wherein the mobile node supports at least one of the network mobility management protocols. The mobility management modules correspond to the network mobility management protocols and the templates, and are used to implement the network mobility management protocols. The platform controller notifier is used to monitor an advertisement signaling packet sent to the mobile node, and a registration request packet from the mobile node, and to send the registration request packet to the platform controller, wherein a user of the mobile node configures the mobile node to use a mobility management protocol selected from at least one mobility management protocol that is mutually supported by the mobile node and the network node so as to enable the mobile node to issue the registration request packet. The mobile node information database is used to store information of the mobile node in the registration request packet.

### BRIEF DESCRIPTION OF THE DRAWINGS

Other features and advantages of the present invention will become apparent in the following detailed description of the preferred embodiment with reference to the accompanying drawings, of which:

FIG. 1 is a diagram showing the architecture of a system for implementing a preferred embodiment of the method for reconfiguring a mobility platform according to the present invention;

FIG. 2 is a flowchart of the preferred embodiment;

FIG. 3 is a block diagram showing a preferred embodiment of a network node for reconfiguring a mobility platform according to the present invention;

FIG. 4 is a block diagram showing a preferred embodiment of a mobile node for reconfiguring a mobility platform according to the present invention;

FIG. 5 is a schematic diagram showing a protocol stack used in the present invention;

FIG. 6 is a flowchart showing the operational flow of the network node according to the present invention;

FIG. 7 is a flowchart showing the operational flow of the mobile node according to the present invention;

FIG. 8 is a flowchart showing the flow of the network node for processing a registration request packet according to the present invention; and

FIG. 9 is a flowchart showing the flow of the mobile node for processing an advertisement signaling packet.

### DETAILED DESCRIPTION OF THE PREFERRED EMBODIMENT

Similar to the concept of redefinition proposed for radio, the present invention proposes a reconfigurable core network architecture. Due to the reconfigurability of the core network architecture, a network service provider can dynamically provide different communications protocols for use by clients. For the user, he/she can select a suitable network protocol according to his/her preference or requirements of an executed application program. The protocols can be options that have been configured in advance, or options provided by the service provider itself. Even if a new communications protocol is added, the architecture of this invention can minimize the incompatibility and contradictions among the communications protocols, thereby contributing to the enhancement of the flexibility and tolerance of the entire system. Hence, in an environment of the reconfigurable core network architecture proposed by the present invention, all the existing network communications protocols and network communications protocols that will be drawn up in the future can completely coexist. Besides, the user can freely select the wireless network technology that best suits the environment he/she is in or that best meets the requirements of the application program currently in use.

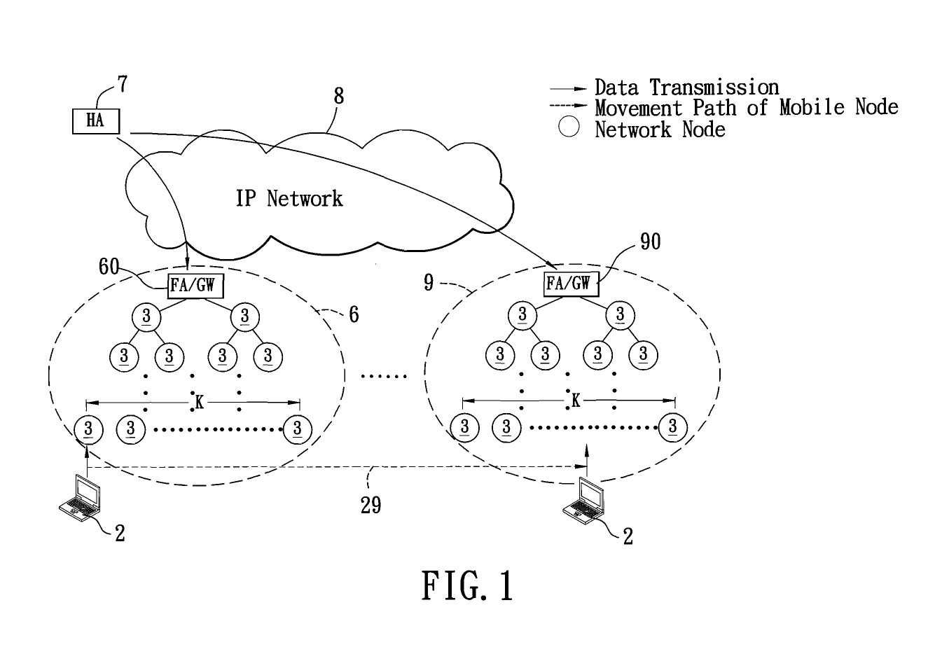

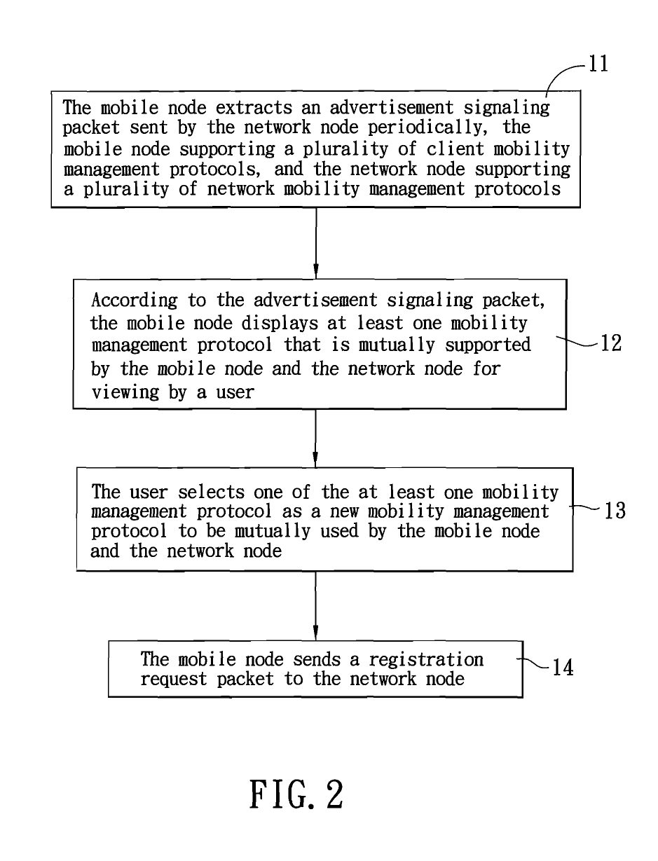

Referring to FIGS. 1 and 2, the method for reconfiguring a mobility platform according to the present invention is adapted for reconfiguring a mobility platform of a mobile node 2 and a network node 3 in a new domain when the mobile node 2 roams into the new domain and moves from a micro-domain 6 to another micro-domain 9 along a movement path 29 as shown in FIG. 1. As shown in FIG. 2, a preferred embodiment of the method for reconfiguring a mobility platform according to the present invention includes the following steps. In step 11, the mobile node 2 extracts an advertisement signaling packet sent by the network node 3 periodically. The mobile node 2 supports a plurality of client mobility management protocols. The network node 3 supports a plurality of network mobility management protocols.

Subsequently, in step 12, according to the advertisement signaling packet, the mobile node 2 displays at least one mobility management protocol that is mutually supported by the mobile node 2 and the network node 3 on a display (not shown) of the mobile node 2 for viewing by a user of the mobile node 2. Then, in step 13, the user selects one of the at least one mobility management protocol as a new mobility management protocol to be mutually used by the mobile node 2 and the network node 3. Thereafter, in step 14, the mobile node 2 sends a registration request packet to the network node 3.

A system platform for implementing the method for reconfiguring a mobility platform according to the present invention can be referred to as a reconfigurable architecture and mobility platform (RAMP). FIG. 1 depicts a generic architecture of a macro-domain and a plurality of micro-domains (e.g., micro-domains 6, 9). The network nodes 3 in each micro-domain are connected as a complete binary tree having K leaf nodes. In each micro-domain, different micro-mobility management protocols can be executed. All micro-domains can be connected through an IP network 8. Alternatively, these micro-domains can also be connected together directly. When the mobile node 2 moves among the micro-domains, the micro-domains execute a macro-mobility management protocol. Assuming the macro-mobility management protocol used is MIP, a home agent (HA) 7 needs to be used. As long as the HA 7 is inside a home network of the mobile station, the HA 7 can be located anywhere. If MIP is operated in a foreign agent (FA) mode, a FA is required in each micro-domain. The location of the FA depends on the type of micro-mobility management protocol used in the micro-domain. Usually, FA is co-located with a router or gateway (GW) which connects the micro-domain to other networks, such as the FA/GW 60, 90 shown in FIG. 1.

The RAMP includes two major components: the mobile node 2 and the network node 3. Each router in a micro-domain is co-located with a network node 3. By examining the RAMP advertisement signaling packet which is sent by the network node 3 periodically, the mobile node 2 can identify the mobility management protocols that the visited micro-domain can support. Then, the mobile node 2 can register with the network node 3 using the RAMP registration request packet.

The RAMP registration request packet includes the mobility management protocol chosen by the mobile node 2 and other related information. Thus, the network node 3 and the mobile node 2 can decide the most desirable mobility management protocol to use. When moving between the micro-domains, the mobile node 2 will also register with FA/GW 60, 90 and HA 7. Unlike some proposed protocols, registrations of macro-mobility management protocols and micro-mobility management protocols in RAMP are separated. That is, RAMP registration and MIP registration are processed separately. Although combining signaling messages for macro- and micro-mobility management protocols can reduce signaling flows, it limits the choice of macro-mobility management protocol. In addition to MIP, RAMP can use other macro-mobility management protocols, such as mobility management protocols based on Session Initiation Protocol (SIP). After registration, user packet transmission can be conducted in the macro-domain using MIP. The micro-mobility management protocol negotiated by the mobile node 2 and the network node 3 will be used for the micro-domain.

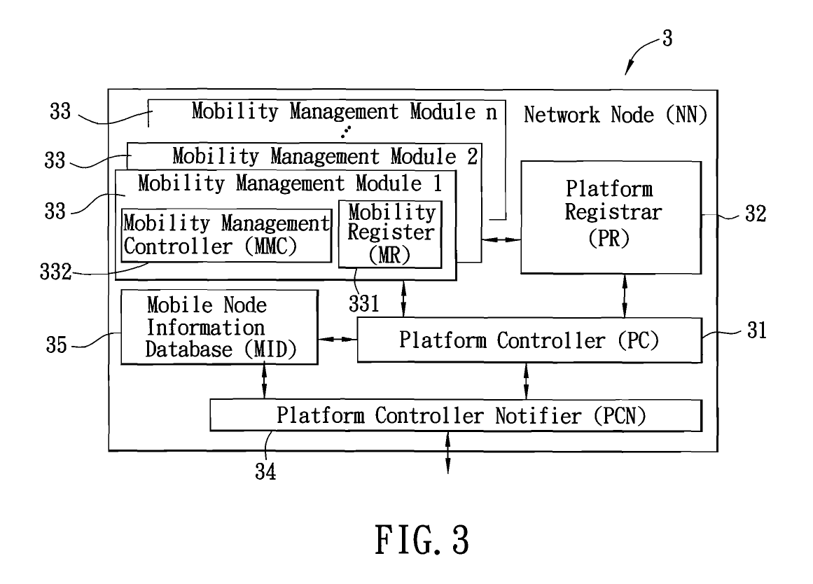

Referring to FIGS. 1 and 3, a preferred embodiment of the network node 3 includes a platform controller notifier 34, a mobile node information database 35, a platform registrar 32, a plurality of mobility management modules 33, and a platform controller 31.

The platform controller notifier 34 monitors all the packets in all the interfaces. If the platform controller notifier 34 detects a signaling packet, it will notify the platform controller 31. If the received packet is a user packet, the platform controller notifier 34 will decide whether or not to notify the platform controller 31 depending on the type of the mobility management protocol. If signaling messages according to the mobility management protocol are implicit in the user packets, the platform controller notifier 34 will notify the platform controller 31. For a normal user packet, the platform controller notifier 34 will examine whether the source address of the packet matches one of the items recorded in the mobile node information database 35. If there is a match, the platform controller notifier 34 will deliver the packet to the platform controller 31. That is, the user packet was sent by a RAMP-aware mobile node 2. Otherwise, the packet will be passed to a normal protocol stack. That is, the user packet was sent by a non-RAMP-aware mobile node 2.

The mobile node information database 35 stores information of every RAMP-aware mobile node 2 in the micro-domain. The information includes the type of mobility management protocol the mobile node 2 intends to use or is using, the IP address of the mobile node 2, and the manner of connecting to the mobile node 2.

The platform registrar 32 records templates of all mobility management protocols which have been implemented in the network node 3. Each template is an abstract of the corresponding protocol. For all mobility management protocols supported by RAMP, corresponding templates should be defined. The templates should be defined by developers of the protocols. Therefore, the platform controller 31 knows which mobility management protocols are available in the micro-domain and how to communicate according to each protocol.

Each of the mobility management modules 33 (such as first, second, . . . and nth mobility management modules) is an implementation of a corresponding mobility management protocol. Each mobility management module 33 includes a mobility register (MR) 331 and a mobility management controller (MMC) 332. The mobility register 331 registers with the platform registrar 32, and sets up a communications channel with the platform controller 31 after the platform registrar 32 has checked that all the functions defined by the platform registrar 32 have been implemented. The mobility management controller 332 controls the communication between the mobility management module 33 and the platform controller 31.

The platform controller 31 is a central controller of the RAMP network node 3. A RAMP header is defined in the present invention to transport signaling packets. Each signaling packet to and from the mobile node 2 will be first processed by the platform controller 31. Upon receipt of a signaling packet from the mobile node 2, the platform controller 31 will parse the RAMP header to obtain the necessary information. Then, the platform controller 31 will communicate with the platform registrar 32 and the mobile node information database 35 to determine to which of the mobility management modules 33 the packet should be directed. On the other hand, when the platform controller 31 is triggered by the mobility management module 33 to send a signaling packet, the platform controller 31 will first communicate with the mobile node information database 35 to compose a RAMP header. Subsequently, the platform controller 31 will send the RAMP header containing data generated by the mobility management module 33 to the platform controller notifier 34. If the platform controller 31 receives a user packet which is not a signaling packet, the packet will be passed between the corresponding mobility management module 33 and the platform controller notifier 34 without adding a RAMP header.

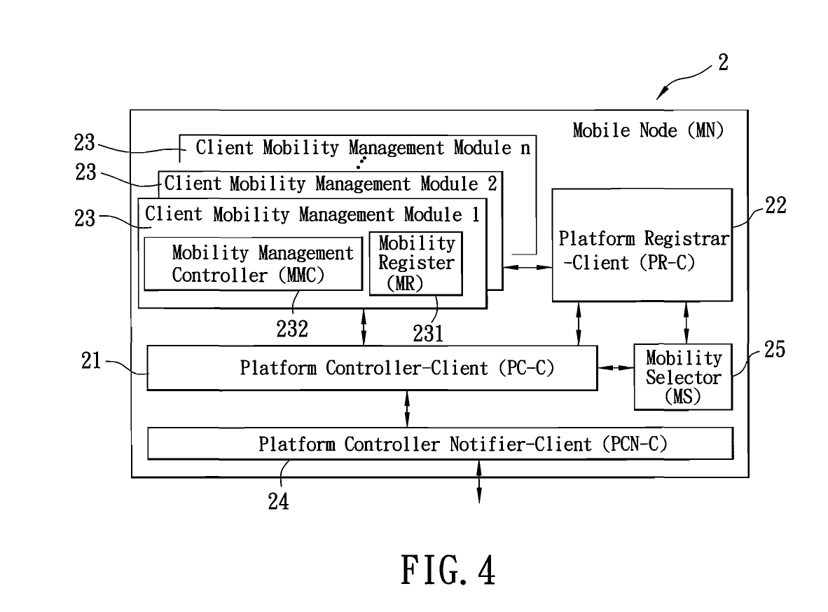

Referring to FIGS. 1 and 4, a preferred embodiment of a mobile node 2 includes a platform controller notifier-client 24, a mobility selector 25, a platform registrar-client 22, a plurality of client mobility management modules 23, and a platform controller-client 21.

The platform controller notifier-client 24 monitors all the packets entering and exiting the mobile node 2, and sends the signaling packets related to the present invention to the platform controller-client 21. The platform controller notifier-client 24 processes the signaling packets in a manner similar to that adopted by the platform controller notifier 34 of the network node 3. For user packets, since the platform controller notifier-client 24 knows itself to be a RAMP-aware mobile node 2, it will process the packets accordingly.

The mobility selector 25 allows the user to dynamically select a mobility management protocol to execute. By communicating with the platform registrar-client 22, the mobility selector 25 knows which protocols the mobile node 2 can support. The mobility selector 25 also learns the capability of the network from the RAMP advertisement. Therefore, the mobility selector 25 knows which mobility management protocols are mutually supported by the mobile node 2 and the network. After the user has decided on the desired protocol, the mobility selector 25 informs the platform controller-client 21 of the final selection.

The platform registrar-client 22 records templates of all the mobility management protocols that have been implemented inside the mobile node 2. Thus, the platform controller-client 21 knows which mobility management protocols are available in the micro-domain, and how to communicate according to each protocol.

Each of the client mobility management modules 23 (such as first, second, . . . , and the nth client mobility management modules shown in FIG. 4) is an implementation of a corresponding mobility management protocol. Each client mobility management module 23 includes a mobility register 231 and a mobility management controller 232. The mobility register 231 registers with the platform registrar-client 22, and sets up a communications channel with the platform controller-client 21 after the platform registrar 22 has checked that all the functions defined by the platform registrar-client 22 have been implemented. The mobility management controller 232 controls the communication between the client mobility management module 23 and the platform controller-client 21.

The platform controller-client 21 is a central controller of the RAMP mobile node 2, and is responsible for managing and communicating with other components of the mobile node 2. The platform controller-client 21 is also similar to the platform controller 31 of the network node 3. The difference resides in that the platform controller-client 21 communicates with the mobility selector 25 instead of the mobile node information database 35.

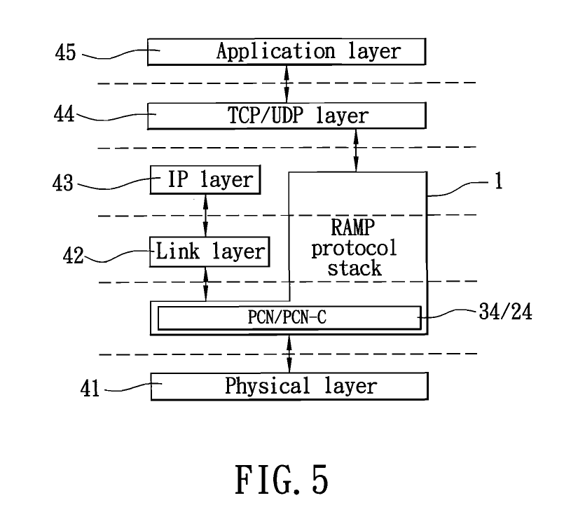

Referring to FIGS. 3, 4 and 5, an implementation program of the present invention can be, but is not limited to, C++ program language developed for the Linux operating system. The implementation program can be divided into two parts: one of which is installed at the network node 3, and the other of which is installed at the mobile node 2. The RAMP protocol stack of the present invention can coexist with the standard protocol stack, and will not interfere with each other. As shown in FIG. 5, the standard IP protocol stack includes a physical layer 41, a link layer 42, an IP layer 43, a Transmission Control Protocol/User Datagram Protocol (TCP/UDP) layer 44, and an application layer 45. The architecture of the RAMP 1 traverses the connecting layer 42 and the IP layer 43. This is because some mobility management protocols traverse these two layers. The platform controller notifier/the platform controller notifier-client (PCN/PCN-C) 34/24 of this invention is a thin layer disposed between the link layer 42 and the physical layer 41. The PCN/PCN-C 34/24 filters the RAMP packet and sends the same to the PC/PC-C 31/21 (see FIGS. 3 and 4). The other packets will be sent to the standard protocol stack. Although RAMP adds reconfigurability, the realization of RAMP will not change the standard IP protocol and routing. All the network nodes and the user nodes can execute IP protocols and application programs as usual no matter whether they can recognize RAMP or not. Therefore, the present invention ensures that the connection during communication of the application layer 45 will not be interrupted when the mobile node 2 is roaming, and that the network stacking architecture and operation of the original operating system will not be affected.

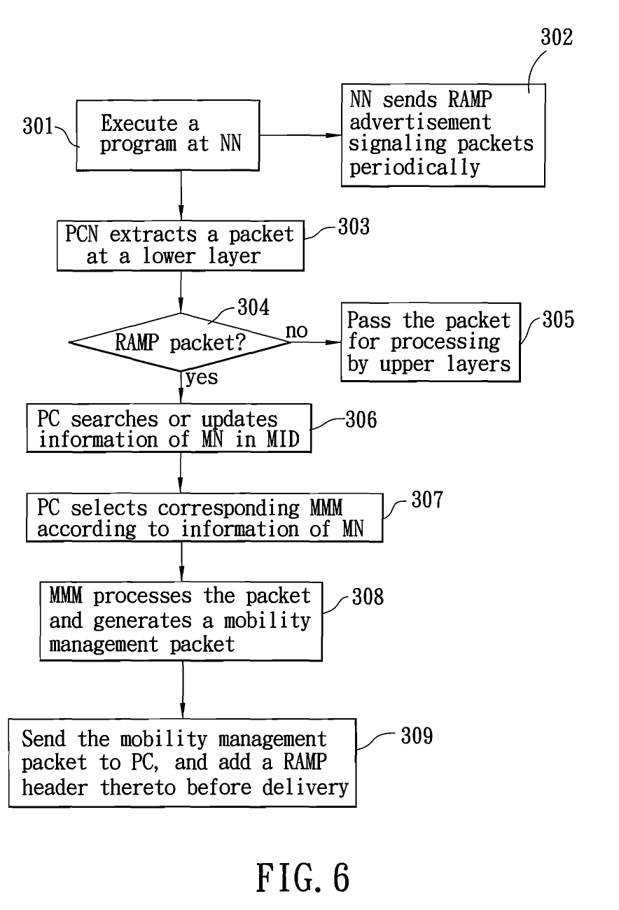

Referring to FIGS. 3, 5 and 6, the operational flow of the network node 3 according to the present invention includes the following steps. First, as shown in step 301 of FIG. 6, an implementation program of the network node 3 is executed. Then, in step 302, the network node 3 sends RAMP advertisement signaling packets periodically. Besides, in step 303, the network node 3 can simultaneously use the platform controller notifier 34 to extract a packet at a lower layer.

After the platform controller notifier 34 has extracted the packet at the lower layer, in step 304, the platform controller notifier 34 further determines whether the packet is a RAMP packet. If no, in step 305, the platform controller notifier 34 passes the packet for processing by upper layers of the link layer 42 and the IP layer 43 (see FIG. 5) of the standard IP protocol.

If the determination result in step 304 is yes, i.e., the packet is a RAMP packet, in step 306, the platform controller 31 searches or updates the information of the mobile node 2 in the mobile node information database 35. Whether it is for the network node 3 or the mobile node 2, the operational flow of the present invention can be divided into four parts: mechanism of processing roaming, processing of data transmission, change of roaming protocol, and termination of transmission connection. The search operation in step 306 is directed to the processing of data transmission. The updating operation in step 306 is directed to the mechanism of processing roaming, the change of roaming protocol, and the termination of transmission connection. Then, instep 307, the platform controller 31 selects the corresponding mobility management module 33 according to the obtained information of the mobile node 2. Subsequently, in step 308, the mobility management module 33 processes the packet, and generates a mobility management packet. Next, in step 309, the mobility management packet is transmitted to the platform controller 31, and a RAMP header is added thereto before delivery.

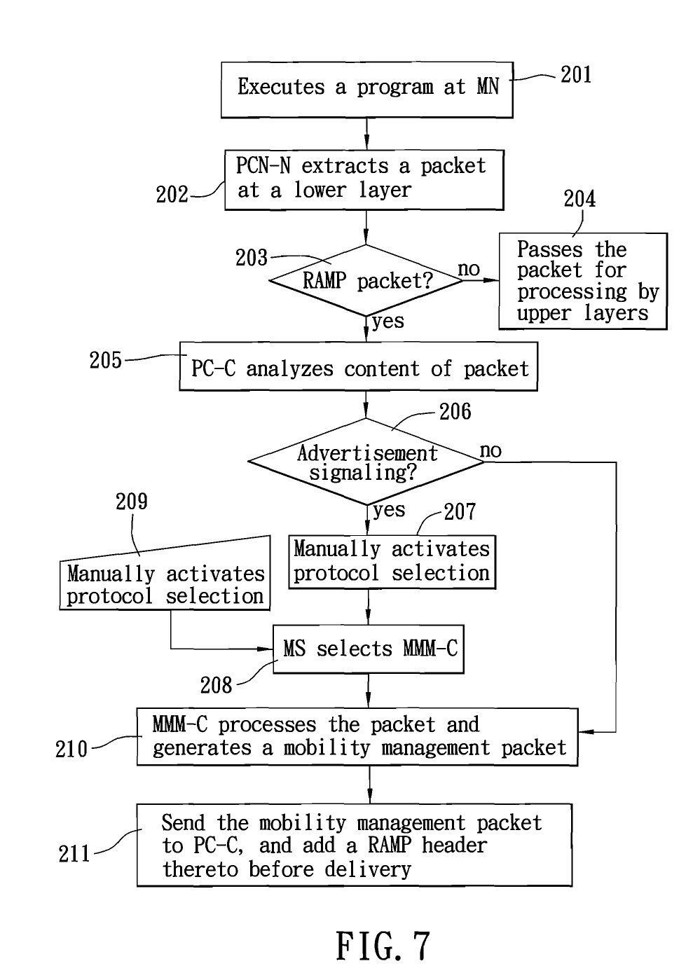

Referring to FIGS. 4, 5 and 7, the operational flow of the mobile node 2 according to the present invention includes the following steps. First, as shown in step 201 of FIG. 7, an implementation program of the mobile node 2 is executed. Then, in step 202, the mobile node 2 uses the platform controller notifier-client 24 to extract a packet at a lower layer.

In step 203, after the platform controller notifier-client 24 has extracted the packet at the lower layer, it further determines whether the packet is a RAMP packet. If no, in step 204, the platform controller notifier-client 24 passes the packet for processing by the upper layers of the link layer 42 and the IP layer 43 (see FIG. 5) of the standard IP protocol.

If it is determined to be yes in step 203, i.e., the packet is a RAMP packet, in step 205, the platform controller-client 21 analyzes the packet content. Subsequently, in step 206, the platform controller-client 21 determines whether the packet is an advertisement signaling packet. If yes, in step 207, the user manually activates the mobility selector 25 to select a desired available protocol. Then, in step 208, the mobility selector 25 selects the corresponding client mobility management module 23 according to the user's selection. Alternatively, in step 209, the user may manually activate the mobility selector 25 at any time to select another protocol, and the mobility selector 25 will select the corresponding client mobility management module 23 according to the user's selection in step 208. Next, in step 210, the client mobility management module 23 processes the packet, and generates a mobility management packet. Subsequently, in step 211, the mobility management packet is sent to the platform controller-client 21, and a RAMP header is added thereto before delivery.

In step 206, if the platform controller-client 21 determines that the received packet is not an advertisement signaling packet, which indicates that the packet is a data packet, steps 210 and 211 are directly performed.

Referring to FIGS. 3, 4, 8 and 9, the first operational flow, i.e., the mechanism of processing roaming, of the network node 3 and the mobile node 2 of the present invention is illustrated hereinbelow.

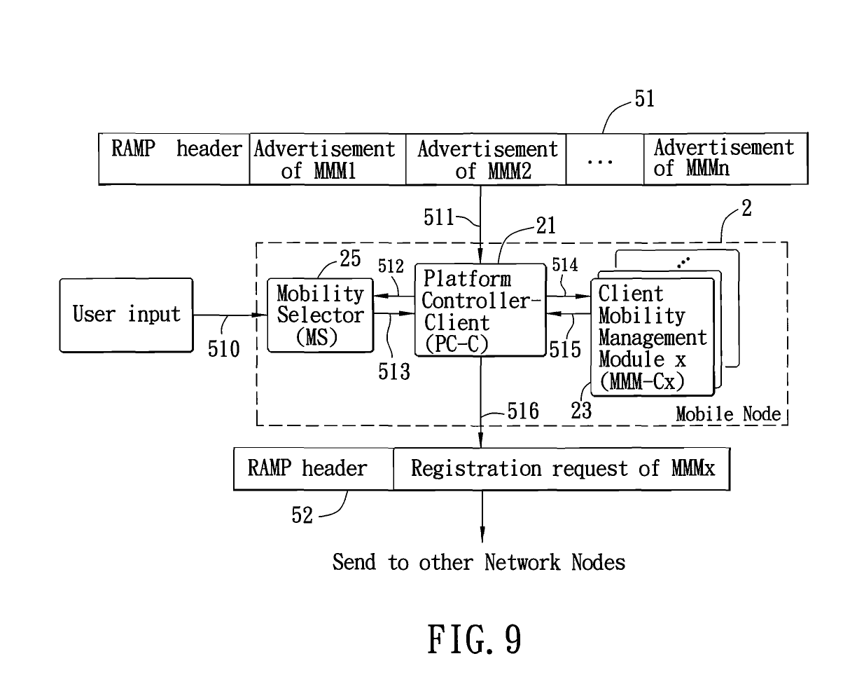

Referring to FIG. 9, the mechanism of processing roaming at the mobile node 2 is as follows. Initially, as shown by a message flow 511, the platform controller-client 21 of the mobile node 2 will receive an advertisement signaling packet 51 sent from the network node 3. Then, the platform controller-client 21 will parse a RAMP header of the advertisement signaling packet 51 to obtain the capability of the network, and send the obtained information, such as that shown in the message flow 512, to the mobility selector 25. As mentioned earlier, the mobility selector 25 can determine the mobility management protocol the user intends to use by reading the selection message flow 510 inputted by the user. Then, as shown in message flow 513, the mobility selector 25 informs the platform controller-client 21 of the user's selected mobility management protocol. Next, the platform controller-client 21 will compose a header of the RAMP registration request packet 52. In addition, in message flow 514, the platform controller-client 21 triggers the corresponding client mobility management module 23 (e.g. the client mobility management module x) to generate a registration request according to the selected mobility management protocol, which is attached as a payload of the registration request packet 52. Then, in message flow 515, the client mobility management module 23 sends the registration request packet 52 to the platform controller-client 21. Finally, in message flow 516, the registration request packet 52 will be sent to the network. If the advertisement signaling packet 51 is received by a non-RAMP mobile node, it will be discarded.

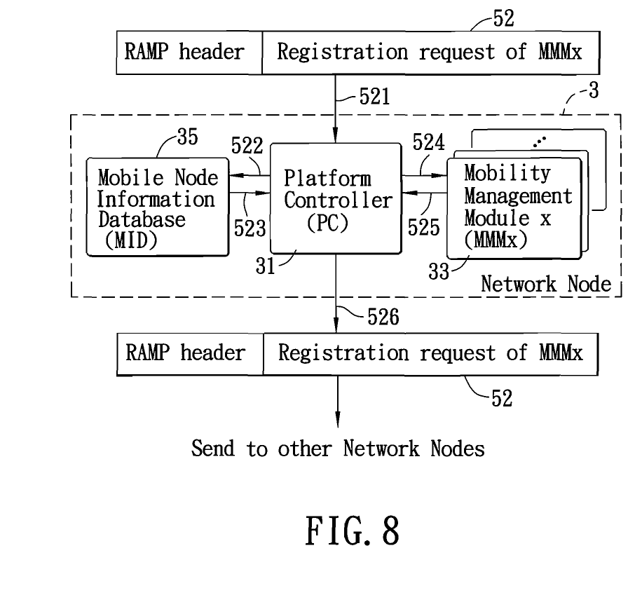

As shown in FIG. 8, the mechanism of processing roaming at the network node 3 is as follows. As mentioned earlier, the network node 3 can be co-located with the router of the micro-domain. As shown in message flow 521, the platform controller 31 of the network node 3 receives the registration request packet 52 from the mobile node 2, and parses the RAMP header to obtain the IP address, selection of protocol, and the requested action of the mobile node 2. As shown in message flow 522, the platform controller 31 then uses the above information to communicate with the mobile node information database 35. Subsequently, the mobile node information database 35 creates an entry of record to store the aforesaid information of the mobile node 2. Next, as shown in message flow 523, the mobile node information database 35 responds to the platform controller 31. In message flow 524, the platform controller 31 directs the packet to the mobility management module 33 (e.g., the mobility management module x) specified by the RAMP registration request packet 52. After the corresponding mobility management module 33 has received the registration request packet 52, it stores the information related to the corresponding mobility management protocol, records the current location of the mobile node 2 according to that information, and finally sets the rules for transferring the data packet of the mobile node 2. Thereafter, the corresponding mobility management module 33 will determine whether the registration request packet 52 needs to be sent to other network nodes in the domain according to different protocol designs. If yes, in message flows 525 and 526, the registration request packet 52 is sent via the platform controller 31 and the network to the other selected network nodes. If no, a reply signaling is generated and is sent to the mobile node 2 via the platform controller 31 and the network so as to inform the mobile node 2 of the success or failure of the registration (not shown).

Referring to FIGS. 3 and 4, the second to fourth operational flows of the network node 3 and the mobile node 2, i.e., processing of data transmission, change of roaming protocol, and termination of transmission connection, according to the present invention will be described as follows.

The processing of data transmission relates to how a data packet should be transmitted and received at the mobile node 2 and the network node 3 after successful registration of the mobile node 2. On the side of the mobile node 2, when the mobile node 2 successfully registers with the network node 3, it can successfully connect with a wireless access point controlled by the network node 3. By treating the wireless access point as a predetermined gateway, the mobile node 2 can successfully send the packet to the network. When the mobile node 2 finds that the IP destination address of the packet sent from the wireless access point is the home address of the mobile node 2, it will take the packet, thereby successfully receiving the packet sent over the network. On the side of the network node 3, when the network node 3 receives a packet sent by the mobile node 2 to a public network, the network node 3 will transfer the packet in accordance with the usual IP routing mechanism. When the network node 3 receives a packet to be sent to the mobile node 2, the network node 3 will first find out the protocol selected by the mobile node 2 during registration, and then transfer the packet according to the mechanism of the selected protocol.

The change of roaming protocol is related to the operational flows of the mobile node 2 and the network node 3 when the mobile node 2 has established a connection with the network node 3 and when the mobile node 2 desires to change the protocol for processing mobility management. On the side of the mobile node 2, as mentioned earlier, the mobility selector 25 will read the protocol the user wants to change to, and determines whether the domain supports the protocol. The platform controller-client 21 will be notified if the protocol is supported. On the contrary, the user will be requested to input another protocol. Then, the platform controller-client 21 will notify the client mobility management module 23 to which the selected protocol corresponds. The corresponding client mobility management module 23 will generate the data required for a re-registration request packet of the protocol, and send it to the platform controller-client 21. Then, the platform controller-client 21 adds important information of the mobile node 2 to the re-registration request packet sent from the client mobility management module 23, and sends the same to the network node 3through the network. On the side of the network node 3, when the platform controller 31 receives the re-registration signaling issued by the mobile node 2, it will first analyze and inspect the re-registration signaling, e.g., whether the mobile node 2 has selected a mobility management protocol not supported by the network node 3. If the platform controller 31 confirms the re-registration signaling to be legitimate, it will update the mobile node information database 35 with the important information of the mobile node 2 in the signaling, send the re-registration signaling to the mobility management module 33 to which the selected protocol corresponds so as to establish a communications channel between the platform controller 31 and the mobility management module 33, and cuts off the communications channel between the platform controller 31 and the previous mobility management module 33. Subsequently, after the mobility management module 33 to which the newly selected protocol corresponds has received the re-registration signaling, it stores the information related to the mobility management protocol, records the current location of the mobile node 2 according to the information, and finally changes the rules for transferring the data packet of the mobile node 2. In addition, the mobility management module 33 to which the newly selected protocol corresponds determines whether the re-registration request packet needs to be sent to other network nodes 3 in the domain according to the designs of different protocols. If yes, the re-registration packet is sent to the selected network node 3 through the platform controller 31 and the network. If no, a reply signaling is generated, and is sent back to the mobile node 2 through the platform controller 31 and the network so as to notify the mobile node 2 of the success or failure of the re-registration.

The termination of the transmission connection is related to the operational flows of the mobile node 2 and the network node 3 when the mobile node 2 desires to terminate the connection. On the side of the mobile node 2, the platform controller-client 21 sends a terminate registration signaling packet to the network. On the side of the network node 3, when the platform controller 31 receives the terminate registration signaling from the mobile node 2, the platform controller 31 will delete the information related to the mobile node 2 from the mobile node information database 35. In addition, the platform controller 31 will notify the corresponding mobility management module 33, and the mobility management module 33 will delete the record of the location of the mobile node 2. Then, the corresponding mobility management module 33 will determine whether the terminate registration request packet needs to be sent to other network nodes 3 in the domain according to the designs of different protocols. If yes, the terminate registration signaling packet is sent to the selected other network nodes 3 through the platform controller 31 and the network. If no, the network node 3 generates a reply signaling which is sent to the mobile node 2 through the platform controller 31 and the network so as to notify the mobile node 2 of the success or failure of the termination of registration.

Therefore, the system architecture which is implemented according to the present invention has flexibility, extensibility and compatibility. Because of flexibility, the user can freely select a suitable protocol from the protocols provided by the network and, after making a decision, can still request the network to change the protocol. The network end will then be responsible for the necessary processing. In addition, since the extensible RAMP specifies a common interface to integrate the different mobility management protocols, even if new mobility management protocols are developed in the future, the new protocols can still be easily integrated into the platform provided by RAMP. Furthermore, because of compatibility, i.e., RAMP provides the functionality of reconfiguring mobility management protocols and does not change the original IP protocol and routing in implementation, all the network nodes 3 and the mobile nodes 2 can still execute the application programs on the IP normally.

In sum, in the method for reconfiguring the mobility platform and the device for applying the method according to this invention, since the mobile node 2 supports various mobility management protocols on the client side, and since the network node 3 also supports various mobility management protocols on the network side, when the mobile node 2 roams into a new domain, the mobility platform of the mobile node 2 and the network node 3 in the new domain can be reconfigured. Thus, a system architecture that is used to implement the present invention has flexibility, extensibility and compatibility.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for reconfiguring a mobility platform, which is adapted for reconfiguring a mobility platform of a mobile node and a network node in a new domain when the mobile node roams into the new domain, said method comprising the following steps:
(a) enabling the mobile node to extract an advertisement signaling packet sent periodically by the network node, wherein the mobile node supports a plurality of client mobility management protocols, and the network node supports a plurality of network mobility management protocols;
(b) according to the advertisement signaling packet, enabling the mobile node to display at least one mobility management protocol that is mutually supported by the mobile node and the network node for viewing by a user;
(c) enabling the user to select one of the at least one mobility management protocol to serve as a new mobility management protocol to be mutually used by the mobile node and the network node; and
(d) enabling the mobile node to send a registration request packet to the network node.

2. A mobile node capable of reconfiguring a mobility platform, said mobile node and a network node in a new domain being reconfigurable to be capable of mutually using a new mobility management protocol when said mobile node roams into the new domain, said mobile node comprising:
a platform controller-client;
a platform registrar-client for recording corresponding templates of a plurality of client mobility management protocols;
a plurality of client mobility management modules corresponding to the client mobility management protocols and the templates for implementing the client mobility management protocols;
a platform controller notifier-client for monitoring an advertisement signaling packet from the network node and sending the advertisement signaling packet to the platform controller-client, wherein the advertisement signaling packet supports at least one of the client mobility management protocols; and
a mobility selector for displaying the client mobility management protocols that are supported by the network node according to said platform registrar-client and the advertisement signaling packet for viewing by a user so as to enable the user to select a new mobility management protocol, and sending the selection result to said platform controller-client so as to notify a corresponding one of said client mobility management modules, thereby generating a registration request packet to be sent to the network node.

3. The mobile node capable of reconfiguring a mobility platform according to claim 2, wherein each of said client mobility management modules includes a mobility register and a mobility management controller, said mobility register being used to register with said platform registrar-client and to establish a communications channel with said platform controller-client, said mobility management controller being used to control communication between said client mobility management module and said platform controller-client.

4. A network node capable of reconfiguring a mobility platform, said network node being located in a new domain into which a mobile node roams, said network node and the mobile node being reconfigurable to mutually use a new mobility management protocol when the mobile node roams into the new domain, said network node comprising: a platform controller;
a platform registrar for recording corresponding templates of a plurality of network mobility management protocols, wherein the mobile node supports at least one of the network mobility management protocols;
a plurality of mobility management modules corresponding to the network mobility management protocols and the templates for implementing the network mobility management protocols;
a platform controller notifier for monitoring an advertisement signaling packet sent to the mobile node, and a registration request packet from the mobile node, and sending the registration request packet to said platform controller, wherein a user of the mobile node configures the mobile node to use the new mobility management protocol selected from at least one mobility management protocol that is mutually supported by the mobile node and said network node, so as to enable the mobile node to issue the registration request packet; and
a mobile node information database for storing information of the mobile node in the registration request packet.

5. The network node capable of reconfiguring a mobility platform according to claim 4, wherein each of said mobility management modules includes a mobility register and a mobility management controller, said mobility register being used to register with said platform registrar and to establish a communications channel with said platform controller, said mobility management controller being used to control communication between said mobility management module and said platform controller.

6. The network node capable of reconfiguring a mobility platform according to claim 4, wherein the information of the mobile node includes a type of the new mobility management protocol, an IP address of the mobile node, and a manner of connecting to the mobile node.

7. A mobility platform configuration method, comprising:
enabling a network node to send out an advertisement signaling packet periodically for receipt by a mobile node when the mobile node roams into a domain within which the network node is located, the advertisement signaling packet indicating a plurality of different mobility management protocols that the network node can support;
with reference to the advertisement signaling packet, enabling the mobile node to determine at least one mobility management protocol that is mutually supported by the mobile node and the network node;
in response to selection by a user of the mobile node of one of the at least one mobility management protocol that is mutually supported by the mobile node and the network node, enabling the mobile node to send out a registration request packet corresponding to the selected mobility management protocol for receipt by the network node; and
in response to the registration request packet, enabling the network node to configure a mobility platform of the mobile node and the network node according to the selected mobility management protocol.

8. A mobility platform configuration method, comprising:
enabling a network node to send out an advertisement signaling packet periodically for receipt by a mobile node when the mobile node roams into a domain within which the network node is located, the advertisement signaling packet indicating a plurality of different mobility management protocols that the network node can support; and
in response to a registration request packet that was received from the mobile node and that was generated according to a mobility management protocol selected by a user of the mobile node and mutually supported by the mobile node and the network node, enabling the network node to configure a mobility platform of the mobile node and the network node according to the selected mobility management protocol.

9. A mobility platform configuration method, comprising:
with reference to an advertisement signaling packet that was sent out by a network node and that indicates a plurality of different mobility management protocols that the network node can support, enabling a mobile node to determine at least one mobility management protocol that is mutually supported by the mobile node and the network node; and
in response to selection by a user of the mobile node of one of the at least one mobility management protocol that is mutually supported by the mobile node and the network node, enabling the mobile node to send out a registration request packet corresponding to the selected mobility management protocol for receipt by the network node;
whereby, the network node configures a mobility platform of the mobile node and the network node according to the selected mobility management protocol in response to the registration request packet.
